(19) United States
(12) Patent Application Publication
(10) Pub. No.: US 2013/0221901 A1
(43) Pub. Date: Aug. 29, 2013

(54) TRI-POWER SYSTEMS

(71) Applicant: Eric Mims, Las Vegas, NV (US)

(72) Inventor: Eric Mims, Las Vegas, NV (US)

(21) Appl. No.: 13/594,403

(22) Filed: Aug. 24, 2012

Related U.S. Application Data
(63) Continuation-in-part of application No. 12/426,760, filed on Apr. 20, 2009, now abandoned.

(51) Int. Cl. H02J 7/00

(52) U.S. Cl. CPC H02J 7/0042
USPC 320/107

(57) ABSTRACT

An electric vehicle comprises a power supply operable on a non-fossil fuel supply and an on-board recharging system that includes a wrapped charging bar and that is operable to prevent a DCPCS from being completely discharged except under express command to do so.

### PRIORITY CLAIM

This is a continuation-in-part of U.S. patent application Ser. No. 12/426,760, filed Apr. 20, 2009, which claimed benefit and priority of U.S. Provisional Patent Application Ser. No. ______, filed Apr. ______, 2008, to inventor Eric Alan Mims, entitled “Tri-Power Systems,” both of which are hereby incorporated herein by reference.

### BACKGROUND OF THE INVENTION

The field of the invention relates to any vehicle or system that requires the use of a motor to power a vehicle or provide power to any form of transportation be it land, sea, air or space.

### DESCRIPTION OF THE RELATED ART

Electric vehicles have been in existence for many years, predating the gas powered car, however the range of electric vehicles and the availability of cheap powerful gas allowed combustion vehicles to leap to the fore front of transportation and construction. Current technology has lead to many strides in electric vehicles but the range and power of these vehicles have left much to be desired. The Tri-power system uses multiple sources of energy to recharge the Direct Charging Power Cells DCPCS while the Carbon Fiber Magnetic Motor CFMM is in use or the system is under a light source or near a heat source. This system has many uses and cannot be limited to electric vehicles. Therefore this patent sets forth a electric car that has superior performance in mileage per charge, recharge time, build quality, 0-30, 0-60 times and 0-100 times, lateral grip and stopping performance from all speeds. In short an electric car that has performance that rivals or out performs the top combustion engine cars on the market today, without the drawbacks of current EV technology. Current electric cars have limited performance in all of these areas. If the car has good performance in 0-60 it has limited range, increase the range and the top speed drops into a range that is unacceptable to the average US consumer. This problem is further compounded by the fact that most EV's have a longer than normal recharge time compared to a gas powered car. Current exotic cars on the market today can hit speeds in excess of 220 MPH (Bugatti Veron 253 MPH and the Koenigsegg CCX) with many small cars being able to hit speeds of 150 MPH or more even though the speed limit in the United States of America is between 55-75 MPH with 65 MPH being the normal speed limit on most interstates. So as a manufacture of EV's we are faced with a problem. Design a car with a maximum speed of 75 MPH and the range of a gas power car it will not be seen as truly ground breaking Why because the public will view it as a transportation device, and not as a true drivers car. However if we build a car that will run as fast or faster without any of the current limitations and the world must take notice, because now all of the reservations that the buying public had about buying an EV have been removed. Hence any EV that has a chance of being accepted must deliver performance, range and build quality and outstandingly so. The power system described in this patent will allow electric vehicles to achieve these goals.

### SUMMARY OF THE INVENTION

The present invention describes an electric vehicle that uses no fossil fuels and has greatly extended range due to the on board recharging systems now known as Tri-power or Tri-powered charging systems. This system greatly reduces recharging times of the DCPCS due to the wrapped charging bar and by changing the shape of the cell to allow faster recharge times with more control of each individual cell, furthermore by providing multiple sources of energy to prevent the DCPCS from being completely discharged except in an emergency.

### BRIEF DESCRIPTION OF THE DRAWINGS

FIG. 1 is a partial, cross sectioned view of a stator in accordance with an embodiment of the invention; and

FIG. 2 is another view of a rotor in accordance with an embodiment of the invention.

### DETAILED DESCRIPTION OF THE INVENTION

The DCPCS are designed to overcome the problem of current automotive battery technology. They are designed to be recharged and discharged at the same time with critical differences the system is designed to be flat only 1-4 inches thick depending upon materials used. Current technology such as Lithium Ion, Nickel Metal Hydride and the like have been used by companies that currently build electric hybrids, DCPCS builds upon the advancements of these by adding a wrapped charging bar for each charging plate in the battery allowing the cells to be charged directly and monitored separately for maximum effectiveness and efficiency. Further the cells are larger and longer than a standard battery increasing charging area while lowering the center of gravity in the vehicle.

With these upgrades to current technology available we will be able to reduce the recharge time of these highbred batteries these advancements can be applied to any type of rechargeable batteries or battery pack. The DCPCS add a safety feature currently not available on any hybrid vehicle. The ability to totally discharge during an accident safely by freezing the battery pack, at extremely low temps the amount of electricity is reduced while a second battery pack will allow the DCPC to be thawed and recharged in case the accident is not very severe and the vehicle can be driven away from the accident. The CFMM is the first and most advanced part of the Tri-power system. Carbon Fiber Magnetic Motor (CFMM) is designed to create a near frictionless armature that can spin in excess of 18,000 rpm in fact the only limit to the CFMM is the transmission that it will be mated to. The system is designed to overcome the weight of magnetic motors while maintaining the power and high RPM characteristics of electromagnetic motors while combining the torque characteristics of Brushless DC motors. The Carbon Fiber Magnetic Motor (CFMM) uses carbon fiber wherever possible to lighten the motor as well as the magnets themselves. Current electromagnetic motors use heavy permanent magnets and electricity to increase the permanent magnet's flux to gain force at one pole of the device. However with the CFMM the system is different we do not use permanent magnets at all. The electric field and flux density is derived from The following Coulomb's law, Gauss's Law, Ampere's Law and Hodge Star Operation

### 1.3.1 Electric Field and Flux Density

The electric field E is derived from Coulomb's law, which expresses the interaction between two electric point charges. Experimentally, it has been shown that
1. Two charges of opposite polarity attract each other, while they repel when they have the same polarity, and hence a charge creates a field of force.
2. The force is proportional to the product of charges.
3. The force acts along the line joining the charges and hence the force field is vectorial.
4. The force is higher when the charges are closer.
5. The force depends upon the electric properties of the medium in which the charges are placed.
Ideally, the electric field is defined in the limit that Dq tends to zero. It is a vector field, radial in the case of a point charge. It comes out of a positive charge and points toward a negative charge. The lines of electric field are tangential to the electric field in every point. Equation is linear with respect to the charge. Hence, when several charges are present, one may vectorially add up the electric fields due to each charge, which yields what is often called the generalized Coulomb's law.
The electric charge may appear in four different forms:
1. It can be punctual, as in Eqn. It is then usually denoted q and measured in coulombs.
2. It can be distributed in space along a line (material of not). It is then usually denoted rl and measured in coulombs per meter (C m-1).
3. It can be distributed in space over a surface (material of not). It is then usually denoted rs and measured in coulombs per square meter (C m-2).
4. It can also be distributed in a volume. It is then usually denoted r and measured in coulombs per cubic meter (C m-3).
When a material is submitted to an applied electric field, it becomes polarized, the amount of which is called the polarization vector. This is due to the fact that, in many circumstances, electric dipoles are created or transformed into the material, which corresponds to what is called the dielectric properties of the material. Hence, the polarization is the electric dipole moment per unit volume, in coulombs per square meter.
The total electric field in a dielectric material is the sum of the applied electric field and of an induced electric field, resulting from the polarization of the material. As a simple example, a perfect electric conductor is defined as an equipotential material. If the points in the material are at the same electric potential, then the electric field must be zero and there can be no electric charges in the material. When a perfect electric conductor is submitted to an applied field, this applied field exists in all points of the material. To have a vanishing total electric field, the material must develop an induced electric field such that the sum of the applied field and the induced field vanishes in all points of the material. The induced field is calculated by taking into account the geometry of the problem and the boundary conditions, which can of course be complicated.

As another example, a human body placed in an applied electric field develops an induced electric field such that the sum of the applied field and the induced field satisfies the boundary conditions at the surface of the body. The total field in the body is the sum of the applied field and of the induced field. Therefore in the carbon fiber magnetic motor we introduce a carbon fiber and metal weave where the metal is fashioned into contact points at the ends of the sheet. When fashioned with a metal bar in the middle and wrapped around it we are able to introduce controlled pulses of electric energy into the metal at multiple points as well as the metal bar creating a stronger magnetic field with lighter weight materials. As such a full metal sheet is not necessary to produce the electromagnet reducing overall weight. With the use of ultra fast switchers such as those found in particle accelerators we are able to create a flexible magnetic field as strong or as weak as needed. The system is also designed to act like a DC motor as well for a dual purpose motor which will allow the motor to function as a DC motor at the start for high torque then switching to CFMM mode for particle accelerator type RPM allowing the CFMM to reach higher RPM in a controlled fashion with less power needed. This is seen from the magnetic field producing a near frictionless environment when using the CFM (Carbon Fiber Magnets) in accelerator mode. With the gains in power and torque the CFMM will be able to accomplish things that other EV motors can not such as providing AC using current technology, as well as alternative sources of power such as regenerative braking and generators using belts or chain or belt driven alternators using current technology such as High output alternators currently available which produce in excess of 400 amps at RPM under 10,000 and driven directly by the motor. The power gain from this source will out weigh the parasitic losses from driving these systems. Furthermore the CFMM technology can be used in this role of high output alternator further reducing the parasitic and frictional losses of current technology while producing far greater amounts of recharging energy to the DCPCS.

Current estimates put peak horse power at 1883.68 with a range time of 1 hour. Nominal HP is 533.33

Wind turbines, the Tri-power system also use Wind Turbines in a ram air induction role via current air intakes in the front, rear and sides of the vehicle depending on the configuration of the vehicle. The Tri-power system uses a bladed turbine to catch the wind flowing through the air ducts in the vehicle, these turbines in turn spin the high output alternators creating another source of power depending upon vehicle configuration this power source will yield another 1600 amps minimum of recharging power at 55-65 MPH. Depending on the size and configuration of the vehicle multiple units can be placed in the air intakes for larger gains of power. Solar cell shell, the outer shell of the vehicle will use solar cells or other forms of energy capture from the sun or heat to increase the power to the DCPCS while the vehicle is moving or sitting still. Solar paint (Dot matrix paint) Carbon Fiber electronics where the outer shell of the vehicle is carbon fiber and uses metal underneath to pull the positive electron from the surface that is left behind when the suns rays strike the surface of the shell. Current estimates put peak power at 1600 amps from this source.

### Drive Train Systems

The main drive train system for Tri-power cars is one main motor mid-mounted to an Mechanical All-wheel drive system similar to Subaru's WRX STI system, upgraded with dog tooth gears to handle the torque and HP ratings. Patristic losses are in the acceptable range, due to power, energy, performance gains as well as lower cost due to known factors. With the amount of control afforded by the CFMM we will be able to provide a level of Traction and Vehicle Dynamic control here to unachievable, by pulsing the magnets we can control the amount of torque and or horse power available at any given time. Hence at full launch for example wheel spin can be kept to a minimum by providing the limit of torque and horse power to all 4 wheels that will provide a small amount of wheel spin without liquefying the tires and providing no meaningful forward progress. We know the current limit of transmission dual clutch technology therefore we will concentrate our efforts in areas that bring greatest gain. Other than the fact that this vehicle is totally electric there are only a few changes that we will have to make to the way the vehicle is built to accommodate our needs. The vehicle should be designed in such a way that people readily accept it as a car but should be awed at the performance style and comfort of this totally electric vehicle. So much care must be taken to meet or exceed the standards set by today's automotive manufactures. Fit and finish must be above average, as mention before the fact that the vehicle will make no engine noise of it's own will have to be addressed with sound deadening material and a good choice of sound system to combat road/tire and wind noise which will undoubtedly seem much louder than in a gas powered vehicle, that has engine and exhaust noise to make some of the sounds made as the vehicle moves.

### Possible Modifications and Variations to the Invention

The vehicle can use any of the systems separately or in tandem or add other systems such as regenerative braking to increase the range and performance of the system. Systems can be removed such as the wind turbine system for use in areas where heavy snow will negatively impact the use of this recharging system and be replaced with another system more suitable to the region, such as an Air motor which uses compressed air to run a secondary motor to produce electricity to help recharge the power pack.

The system is not restricted to road going vehicles such as cars motorcycles trucks or trains the system can be used to power and move any form of transportation be it flight, ship, crane or bulldozer. As well as home and business based systems such as heating and cooling homes providing auxiliary power for buildings est. The DCPCS could be replaced with a capacitor or ultra capacitor. The CFMM could be replaced with a DC Brushless motor or other type of motor in applications where high RPM is not needed or desired or in applications where due to cost factors the CFMM would be to expensive and a suitable replacement would be more cost effective to manufacture. The CFMM can be made smaller for fitment in the wheels of the vehicle or closer to the wheel axle instead of using a 4 wheel transmission system to transfer power to the wheels, in such a case the use of a transmission would be unnecessary as the unit could uses 1 to as many CFMM/Motors as needed for that specific configuration. A 2 or one wheel drive system for lower powered vehicles as needed, multiple transmissions such as a 3-18 plus speed transmission for use in single or low occupant vehicles to large transport units such as 18 wheel trucks where lower gears are needed to boost the torque characteristics and extend range of the power pack.

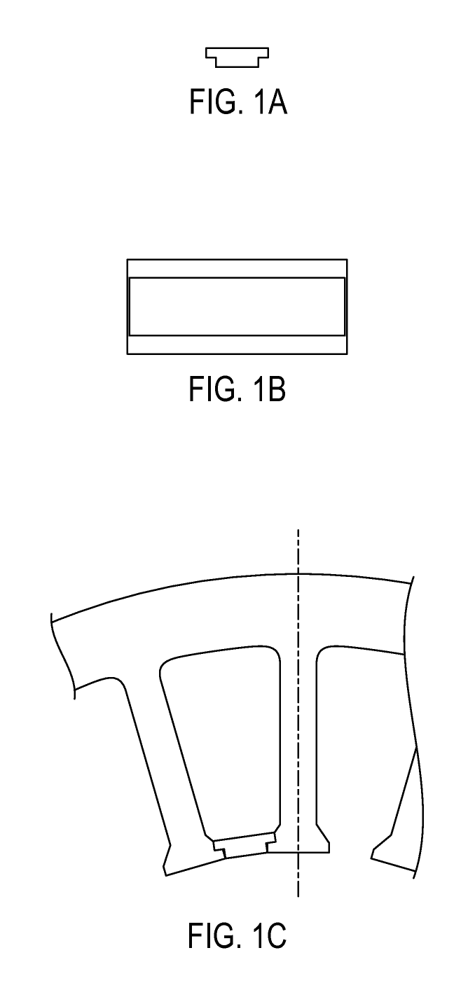

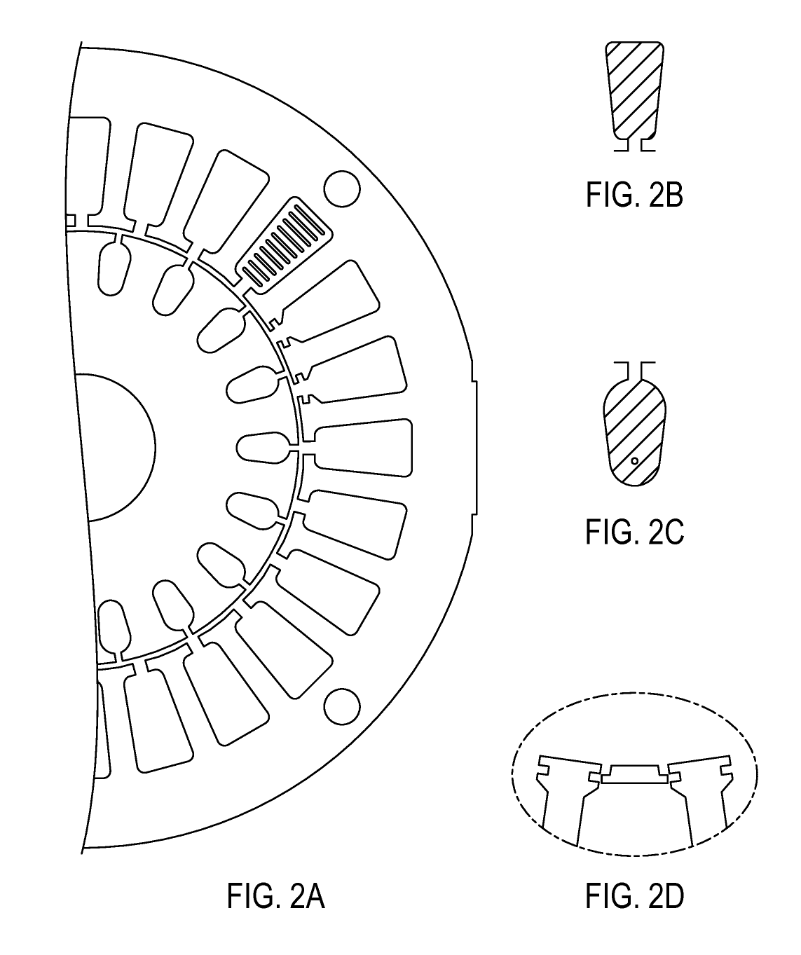

FIGS. 1 and 2 illustrate various aspects of the invention. In this views, an air gap is shown between the rotor and stator. The air gap is the area that the rotor spins within, however due to the gaps in the slots the air is turbulent. As the rotor spins the turbulent air causes the rotor to wobble and shake which will eventually cause motor failure. To counteract this issue, the present inventor has designed a manner to create a skewed rotor to compensate. The slot gap can be helpful because of the manufacture of motors requires it in order to install the copper windings in the slots to create the magnetic flux. In order to fix this issue the T Slot requires a notch at the ends of the slot heads. The T Slot allows the windings to be placed as normal, then when finished the T Slot is “tapped” into place closing the slot gap providing a smooth air gap for the rotor to rotate within decreasing turbulence.

Pulsations and oscillations of the flux under the interpoles must be avoided, as they cause sparking and damage to the commutator. A large air-gap under the interpole and a small tooth pitch help to reduce the effect of slotting upon the flux under the interpole. In general the number of slots between the tips of adjacent poles should be at least 3.

As we reduce/remove the turbulence in the air gap, lighter materials can be used as the motor wobble/shake is reduce/removed (the wobble/shake will be higher in odd numbered stator/rotor combinations which are normally used currently due to the need of a skewed rotor) with the need for an odd numbered rotor/stator removed a even numbered balanced rotor/stator combination can be used further reducing the wobble/shake in the motor. Hereby reducing the amount of heavy metals needed to create a powerful induction motor.

Therefore lighter weight materials such as carbon fiber shafts, stator/rotor combinations with copper wiring greatly reduce the amount of the end product with much higher efficiency throughout.

I claim:

1. An electric vehicle, comprising:
A power supply operable on a non-fossil fuel supply;
an on-board recharging system that includes a wrapped charging bar and that is operable to prevent a DCPCS from being completely discharged except under express directions to do so; and [symbol]
